(19) United States
(12) Patent Application Publication
(10) Pub. No.: US 2015/0007714 A1
(43) Pub. Date: Jan. 8, 2015

(54) DEVICE TOGETHER WITH HYDRAULIC SYSTEM FOR ACTUATING LEAST ONE FIRST HYDRAULIC CONSUMER AND AT LEAST ONE SECOND HYDRAULIC CONSUMER

(71) Applicant: Hydac Fluidechnik GmbH, Sulzbach/Saar (DE)

(72) Inventor: Philipp Hilzendegen, Wadern (DE)

(21) Appl. No.: 13/261,952

(22) PCT Filed: Mar. 13, 2013
(86) PCT No.: PCT/EP2013/000734

§ 371 Date: Sep. 11, 2014

(30) Foreign Application Priority Data
Mar. 14, 2012 (DE) 102012005253.7

(51) Int. Cl. F15B 11/22

(52) U.S. Cl. CPC F15B 11/22
USPC 91/171

(57) ABSTRACT

Device together with hydraulic system for actuating at least one first hydraulic consumer and at least one second hydraulic consumer. A device (32) for actuating at least one first hydraulic consumer (10) and at least one second hydraulic consumer (12), wherein the hydraulic consumers (10, 12) can be supplied with fluid at a predefinable pressure at least via a flow divider (26) for dividing a fluid flow which comes from a pressure supply (P) into predefinable part flows which lead to the respective hydraulic consumer (10, 12), is characterized in that a fluid flow from that hydraulic consumer (IO) with higher pressure loading via the flow divider (26) to that hydraulic consumer (12) with lower pressure loading can be suppressed by means of at least one shut-off device (38) which is arranged between the flow divider (26) and at least one hydraulic consumer (12), and in that the at least one shut-off device (38) is arranged in a fluidic connection (F2) from the flow divider (26) to the hydraulic consumer (12) with lower pressure loading.

The invention relates to a device for actuating at least one first hydraulic consumer and at least one second hydraulic consumer in accordance with the characteristic design of the preamble of claim 1. The invention further relates to a hydraulic system having such a device for actuating two hydraulic consumers.

Such a device is used for example in machines such as loaders for the movement of loads, for example, and in so doing, serves to actuate actuators having working cylinders, in which pistons are displacably or, respectively, movably guided in accordance with a movement of the load that is to be moved. Depending on the positions of the pistons or, respectively, actuators and the load moved thereby, an unfavorable shift in the balance point may lead to the tipping of the machine, which is why these must meet the safety regulations laid out in the safety standard EN 15000 in particular. Accordingly, in the event of a risk of tipping, a movement that increases the load torque must be prevented, and a movement that reduces the load torque must be permitted. During the operation of the machine, a sudden shutdown of the consumers, in particular by means of intense braking decceleration may also cause a tipping of the machine. This problem has thus far been dealt with in that the allowable movement speed is reduced in order to reduce the braking decceleration, wherein the movement speed is advantageously delayed proportional to the actuator position and to the load, or in other words, the movement is slowed. This is contrary to the user-side requirement of faster loading and unloading cycles. Alternatively, The movements of the two actuators can be permanently coupled in such a way that unwanted actuator positions are avoided.

In addition, it is desirable that uniform, “smooth” work be made possible at the limits of the range of movement of the machine, or in other words, when the extreme positions of the actuators have been reached. For example the flow divider, which is designed for a specific volume range, may be subject to leakage to such a degree that a fluid leakage flow is able to flow from one actuator that is allocated to a horizontal movement and that is subject to a higher pressure, to an actuator that is allocated to a vertical movement and that is subject to a lower pressure, and the position of the additional actuator may be perceptibly influenced in the form of an irregularity in the in course of the movement, such as a “jolt”. This situation occurs in particular when the horizontally movable actuator is fully retracted and the vertically movable actuator is fully extended. The known devices for actuating hydraulic consumers such as the actuators, do not reliably suppress fluid leakage flow in this situation.

A device for actuating at least two hydraulic consumers is known from U.S. Pat. No. 5,473,828, which consumers, being designed as hydraulic working cylinders, each have piston rod drives that can be extended different distances out of the cylinder housings for the purpose of actuating identically formed bucket halves of an excavator. Due to the different distances traveled by the piston rod drives, it is possible to raise the bucket mechanism and break loose of the remaining soil foundation when the bucket mechanism is closed and has penetrated a soil mass, wherein the closed excavator bucket is tipped in that the longer working cylinder performs such a tipping movement.

In order to be able to hold the bucket halves in the closed position during the tipping or breaking-loose movement, a control line is provided downstream of a flow divider, which supplies the two sides of the piston of the working cylinders with hydraulic fluid, behind the flow divider pathway, which supplies the working cylinder having the smaller extension length, said control line controlling a 3/2 directional control valve in such a way that, as the pressure increases when breaking loose from the ground, this valve goes to its closed position so that an additional influx of working fluid to this hydraulic cylinder is stopped and this cylinder is held in its position that closes the bucket mechanism, without an overload.

A control system for a fluid pressure actuating drive for controlling an adjustment of a predetermined fluid pressure actuating drive of at least two fluid pressure actuating drives as hydraulic consumers is known from DE 11 2005 001 879 T5, the flow of pressurized fluid of which actuating drives, which is provided by a common fluid pressure source, can be individually distributed by means of a flow divider device. Within the context of this individual distribution, an independent shut-off device is allocated to each hydraulic consumer, which shut-off devices can be actuated by a central control device, wherein operating states at the respective hydraulic consumers are monitored by means of a comprehensive sensor system and cause the control device to supply quantities of fluid to the consumers by means of the respective shut-off device in the form of valves, or to discharge such fluid from these consumers, preferably into a tank. As a result of this separate actuation regarding the respective hydraulic consumer, this known solution makes it possible to perform a fine adjustment or, respectively, fine positioning of the hydraulic consumers, for example in the form of hydraulic actuators, and moreover such an opportunity is created to automatically adapt the position or location of a working tool, for example in the form of an excavator bucket, in accordance with the location of another movable element, for example in the form of a hydraulically actuated load lifting arm. This known solution is structurally complex and a reliable control of fluid leak flows in the above mentioned context is not possible with this known solution.

Starting from this prior art, the object of the invention is to suppress a fluid leakage flow between two hydraulic consumers via a flow divider in a simple and reliable manner, it being possible to supply said consumers with fluid at different pressures.

This object is achieved according to the invention by a device having the features of claim 1 in its entirety, as well as having a hydraulic system in accordance with the characteristic design of claim 4.

A device according to the invention, as well as a hydraulic system comprising such a device, which is distinguished in that a control line is run from the fluid connection, which runs from the hydraulic having the respective higher pressure loading to the flow divider, to the shut-off device in such a way that the higher pressure loading actuates the shut-off device in the direction of the blocking position thereof, so that regardless of the pressure situation of the actuated hydraulic consumer, a fluid pressure that exists in the fluid connection from the hydraulic consumer having a higher pressure loading to the flow divider does not reach the hydraulic consumer having a lower pressure loading, and consequently does not actuate this consumer in an unintended manner.

A fluid pressure that exists in the corresponding fluid connection at most reaches the shut-off device, which blocks a further fluid pathway to the respective other hydraulic consumer.

The at least one shut-off device, which is preferably designed as a valve, and especially preferably as a non-return valve, is advantageously actuated by the fluid pressure flowing through the flow divider, and can advantageously be blocked by the hydraulic consumer with the higher fluid pressure originating from the respective higher pressure loading during the operation of the device. In this advantageous embodiment of the invention, it is ensured that the at least one shut-off device is blocked upon the occurrence of a fluid leakage flow at the flow divider. In an embodiment of the shut-off device as a non-return valve that can be blocked, this valve can advantageously be closed by the control line, wherein the line for actuating the shut-off device is advantageously connected to the fluid connection from the hydraulic consumer having a higher pressure loading to the flow divider, such that said line conducts fluid.

In addition, it is conceivable that fluid pressures arise in both fluid directions between the hydraulic consumers, which are connected to one another via the flow divider, which consumers are subjected to higher and lower pressures in alternation. In so doing, two shut-off devices are advantageously provided, said shut-off devices being allocated to the respective fluid direction, and disposed in the fluid connection from the flow divider to the respective hydraulic consumer having a lower pressure loading. According to the invention, it is also conceivable that a shut-off device could be formed that is effective in both fluid directions and that suppresses corresponding fluid flows. With the help of the device according to the invention, the hydraulic consumer can be used in an unimpeded (“smooth”) manner without disruptions from fluid flows even in special positions of the hydraulic consumer, wherein the solution according to the invention can be implemented in an especially cost-effective manner. Leakage flows, which formerly ran via the flow divider when necessary, are thus reliably avoided.

In order to implement the above mentioned advantageous solutions, it may further be advantageously provided that the control line runs between a connection point of the shut-off device, for the blocking thereof, and a branching point, into which both a fluid line coming from the outlet of a flow divider pathway of the flow divider is discharged, and the additional fluid line, which runs in the direction of the consumer having the higher pressure loading or, respectively, which is connected to this consumer such that it conducts fluid.

The invention further relates to a hydraulic system comprising at least one first hydraulic consumer and at least one second hydraulic consumer, and a device according to the invention for actuating the hydraulic consumers. The device according to the invention may also be manufactured, sold and utilized in a hydraulic system as a tradable unit, independent of the hydraulic consumers and a pressure supply.

In order to use the hydraulic system in a machine for the movement of loads, the first and/or the second hydraulic consumer may be fluid-actuated actuators each having two actuator sides that are separated from one another, which can be connected to the pressure supply for a movement of the respective actuator to guide fluid in an alternating manner. The actuator and the load connected thereto are moved according to the pressure loading of the respective actuator side. The actuators preferably each comprise a piston that can be extended and retracted in a working cylinder, wherein the actuator sides that are allocated to a retracting movement of the respective piston are connected to the flow divider. It is also possible, however, to connect actuator sides that are allocated to an extending movement of the respective piston to the flow divider. In this way, a synchronous run or, in other words, a coordinated movement of the two pistons or, respectively, actuators is ensured, either in the respective direction of retraction or in the respective direction of extension. Combinations of coupled retraction and extension movements are also conceivable.

In a further preferred embodiment of the hydraulic system according to the invention, one of the actuators comprises a telescopic cylinder having a piston that can be extended and retracted therein, preferably in a horizontal direction, and an additional actuator comprises a lifting cylinder having a piston that can be extended and retracted therein, preferably in a vertical direction, wherein the shut-off device is disposed between the flow divider and the lifting cylinder. In so doing, the total movement caused by the actuators is divided into a movement component, preferably in a horizontal direction, and an additional movement component, preferably in a vertical direction, and can be modified accordingly by means of the telescopic cylinder or, respectively, the lifting cylinder. By means of the arrangement according to the invention of the shut-off device between the flow divider and the lifting cylinder and a blocking of the corresponding fluid connection, it is possible to prevent a fluid leakage flow of approximately 5 l/min from reaching the lifting cylinder during operation, for example in the case of a flow divider set up for 150 l/min and a pressure of 150 bar in the telescopic cylinder.

Further advantages and features of the invention will be apparent from the figures and subsequent description of the drawing. According to the invention, the above mentioned and additionally introduced features may be implemented individually or in any combination with one another. The features shown in the figures are purely schematic and not to scale. Shown are:

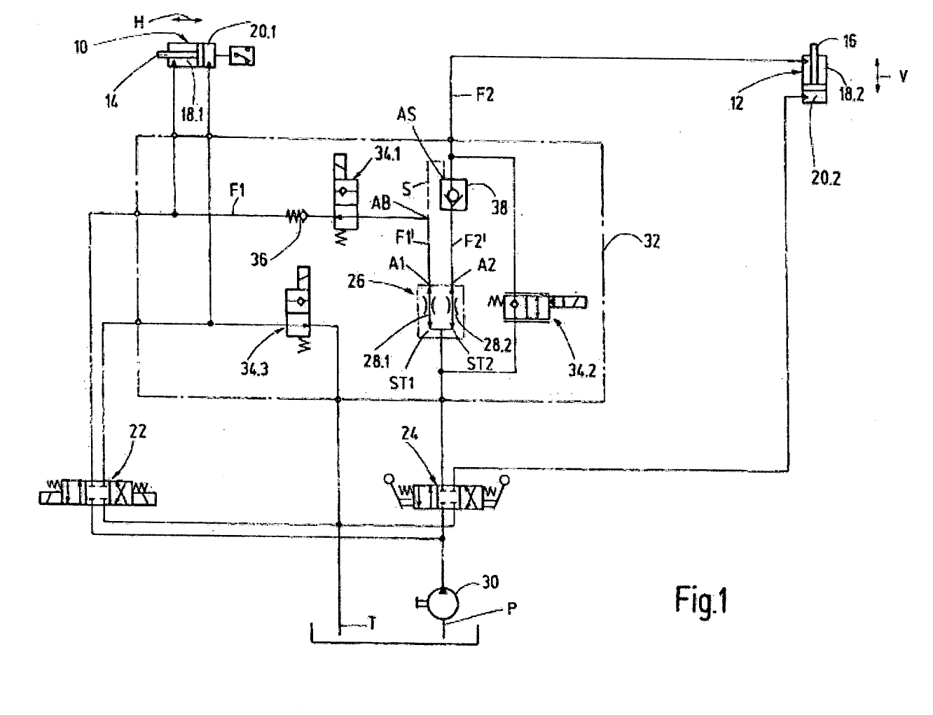

FIGS. 1 to 3 each show a circuit diagram of a hydraulic system equipped with a device according to the invention for actuating hydraulic consumers.

A hydraulic system shown in each of the FIGS. 1 to 3 comprises a first hydraulic consumer 10, which is designed as an actuator having a working cylinder, or more precisely, a telescopic cylinder, and a second hydraulic consumer 12, which is likewise designed as an actuator having a working cylinder, or more precisely, a lifting cylinder. In each of the two hydraulic consumers 10, 12, which are designed as actuators, a first piston 14 or, respectively, a second piston 16 are guided in a displaceable manner, wherein the first piston 14 can be extended and retracted in a horizontal direction H in the corresponding working cylinder, and the second piston 16 can be extended and retracted in a vertical direction V in the corresponding working cylinder.

In order to adjust the position of the respective piston 14, 16 or, respectively, for a corresponding actuator movement, a retraction side 18.1, 18.2 or an extension side 20.1, 20.2 of the corresponding working cylinder is connected to a pressure supply P such that these conduct fluid, and fluid is supplied at a predefinable pressure. Fluid is moved from the pressure supply P to the retraction side 18.1, 18.2 or to the extension side 20.1, 20.2 of the respective hydraulic consumer 10, 12 by means of a pump 30 that can be actuated. Fluid that is displaced during a movement of the respective piston 14, 16 on the retraction side 18.1, 18.2 or on the extension side 20.1, 20.2 can be conveyed back into the tank or, respectively, a reservoir by means of a tank connection T. The superimposing of a lifting movement in a vertical direction V with a translational movement or, respectively, telescoping movement in the horizontal direction is possible with the hydraulic system shown in FIGS. 1 to 3.

A first valve 22, which is designed as a 4/3 directional control valve that can be actuated electromagnetically, and a second valve 24, which is designed as a 4/3 directional control valve that can be actuated are provided for the respective desired supply of fluid to the hydraulic consumers 10, 12. The first valve 22, which can switch between an ON position (left) for the pressure loading of the retraction side 18.1 of the first hydraulic consumer 10, a NEUTRAL position (middle) for closing off all fluid connections, and an OFF position (right) for the pressure loading of the extension side 20.1 of the first hydraulic consumer 10, is connected directly between the pressure supply P and the first hydraulic consumer 10. The second valve 24, which can switch between an ON position (left) for the pressure loading of a retraction side 18.2 of the second hydraulic consumer 12, a NEUTRAL position (middle) or closing off all fluid connections, and an OFF position (right) for the pressure loading an extension side 20.2 of the second hydraulic consumer 12, can be connected between the pressure supply P and the two hydraulic consumers 10,12 such that the second valve 24 is connected directly to the extension side 20.2 of the second hydraulic consumer 12 and to both retraction sides 18.1, 18.2 of the two hydraulic consumers 10, 12.

In order to divide a fluid flow that is conveyed from the pressure supply P via the second valve 24 to the retraction sides 18.1, 18.2 of the hydraulic consumers 10, 12 into corresponding partial flows, a flow divider 26 is provided. The flow divider 26 has a first choke 28.1 and a second choke 28.2, which divide the fluid flow coming from the pressure supply P, which is at 100%, into a first partial flow of 67% that runs to the first hydraulic consumer 10, for example, and into a second partial fluid flow of 33% running to the second hydraulic consumer 12, for example. It is understood that, instead of this fixed, predetermined ratio between the first and second partial flow, the two chokes 28.1, 28.2 may also be designed to that they can be individually adjusted. The flow divider 26 is designed for a volume flow rate range of 150 l/min, for example. In so doing, a compromise must be found between the minimum volume flow rate range, in which the flow divider 26 fulfills its function, and a pressure drop via a second selector valve 34.2 at a maximum volume flow rate. In the case of a low volume flow rate of the fluid flow coming from the pressure supply P, the flow divider 26 functions according to the two chokes 28.1, 28.2.

A non-return valve 36 is provided in a first fluid connection or fluid line F1, from the flow divider 26 to the first hydraulic consumer 10, the non-return valve of which closes in the case of a pressure supply to the retraction side 18.1 of the first hydraulic consumer 10 via the first valve 22, in order to avoid a pressure drop via the first fluid connection F1. A shut-off device 38 is provided in a second fluid connection or fluid line F2 from the flow divider 26 to the second hydraulic consumer 12, which shut-off device is designed as a non-return valve, and which can be blocked via a control line S, which is designed as a leakage flow line, and which is connected to the first fluid connection F1 such that it conducts fluid.

The fluid- and pressure conducting control line S (drawn with a dashed line) runs between a connection point AS of the shut-off device 38 for the blocking thereof, and a branching point AB, into which both a fluid line F1′ coming from the outlet A1 of a flow divider pathway ST1 of the flow divider 26 discharges, and also the additional fluid line F1, which leads in the direction of the consumer 10 having the higher pressure loading. The flow divider pathway ST2 of the flow divider 26 is connected via the outlet A2 of the flow divider 26 to the fluid line F2′, which further leads to an input connection of the shut-off device 38.

The connection point AS as well as the fluid line or connection F2 running to the consumer 12 are connected to the outlet side of the check valve 38, the blocking element of which check valve opens in the direction of the above mentioned outlet side upon obtaining a corresponding fluid pressure, and otherwise, taking into account the differential pressure between the inlet and outlet side of the stop valve 38, the check valve can remain in a closed position.

The flow divider 26 and the shut-off device 38 are part of a device 32 for actuating the two hydraulic consumers 10, 12, wherein the device 32 further comprises the non-return valve 36 and switchable valves 34.1, 34.2, 34.3. A first switchable valve 34.1 is disposed in the first fluid connection F1 from the flow divider 26 to the retraction side 18.1 of the first hydraulic consumer 10. A second switchable valve 34.2 is disposed on the retraction side 18.2 of the second hydraulic consumer 12 via the second valve 24 in order to bypass the flow divider 26 together with a shut-off device 38 in the case of a direct pressure loading of the pressure supply P. A third switchable valve 34.3 is disposed in a direct return line from the extension side 20.1 of the first hydraulic consumer 10 ti the tank connection T, i.e., parallel to the first valve 22.

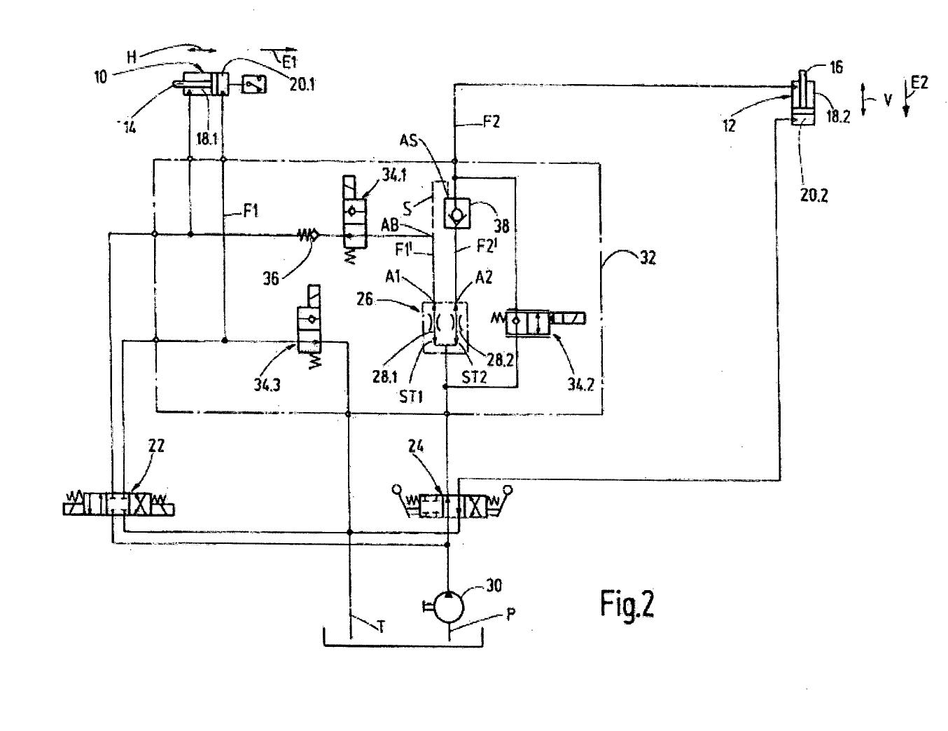

FIG. 2 differs from FIG. 1 in that the second valve 24 shown in the right is in the ON position and accordingly, via the flow divider 26 the retraction sides 18.1, 18.2 of the two hydraulic consumers 10, 12 are subjected to pressure and the respective pistons 14, 16 carry our a horizontal first retraction movement E1 or, respectively, a vertical second retraction movement E2. By means of the partial flows that are directed from the flow divider 26 through the fluid connections F1, F2 to the retraction side 18.1, 18.2 of the respective hydraulic consumer 10, 12, these consumers are permanently coupled and the pistons 14, 16 move in accordance with the partial flows, which are more precisely adjusted in the flow divider 26 by means of the chokes 28.1, 28.2, and in accordance with the partial volumes of the respective working cylinders, predefined on the respective retraction sides 18.1, 18.2, in a predefined ratio to one another. In an application of the hydraulic system in a machine such as a telescopic handler for moving loads, the first piston 14 or, respectively, actuator passes through this permanent coupling during a lowering movement in accordance with the second retraction movement E2 of the second piston 16 or, respectively, actuator, in accordance with the first retraction movement E1. A tipping of the machine as a result of an unfavorable shift in the balance point is hereby effectively avoided. The fluid that is displaced by the movement of the pistons 14, 16 on the extension side 20.1, 20.2 of the respective hydraulic consumer 10, 12 is conveyed back into the tank by means of the tank connection T.

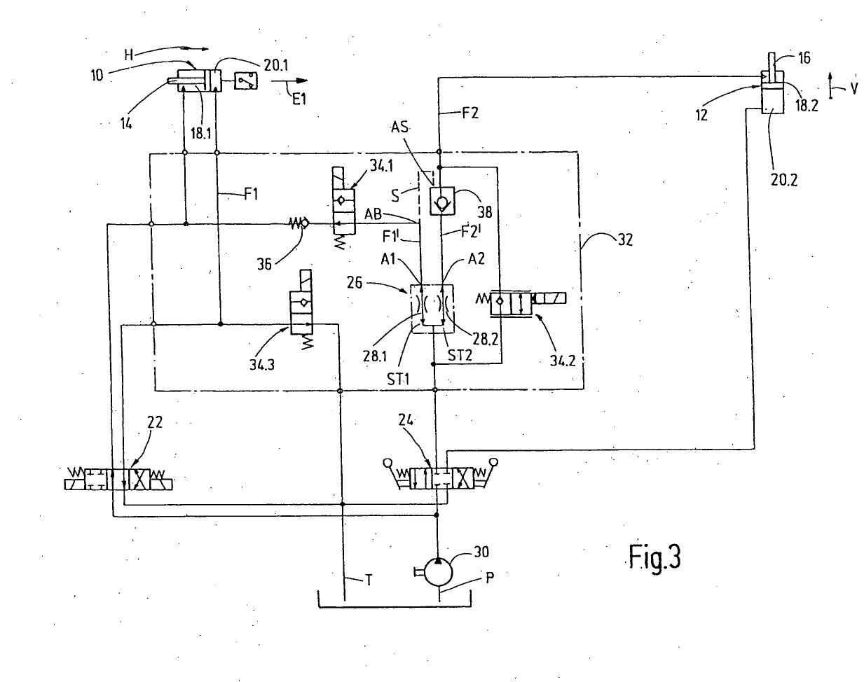

FIG. 3 differs from FIG. 1 in that the first valve 22 shown on the left is on the ON position and accordingly, the retraction side 18.1 of the first hydraulic consumer 10 is subjected to pressure and the first piston 14 performs a retraction movement E1 toward the right in the drawing. Due to the NEUTRAL position of the second valve 24 the prevailing pressure on the retraction side 18.2 of the second spiston 16 exists in the second fluid connection F2 and at the flow divider 26. In the situation shown in FIG. 3, the second piston 16 fully extended out of the working cylinder of the second hydraulic consumer 12, so that a lower pressure exists on the corresponding retraction side 18.2. This lower pressure likewise exists on the flow divider side at the non-return valve 36 in the first fluid connection F1. The above mentioned non-return valve 36 is closed due to the substantially higher pressure of the pressure supply P on the actuator side.

Fluid pressure that exists on the side of the flow divider 26 that is allocated to the first hydraulic consumer 10 or, respectively, in the corresponding section of the first fluid connection F1, can flow through the flow divider 26 nearly unhindered and without the shut-off device 38, would reach the retraction side 18.2 of the second hydraulic consumer 12 and could influence the position of the second piston 16 in an undesirable, in particular “jolting”, manner. Such an undesired influence is prevented by the shut-off device 38 in such a way that the shut-off device 38 is actuated and closed by the fluid pressure that exists on the first fluid connection F1 via the control line S, before such a fluid flow reaches the second fluid connection F2 running to the second hydraulic consumer 12 via the flow divider 26.

As soon as the pressure that exists on the retraction side 18.1 of the first hydraulic consumer 10 is reduced and/or the switch position of the first valve 22 is modified, fluid leakage flows via the flow divider 26 are reduced and become negligible or are entirely prevented at the latest when there is a drop in pressure at the flow divider 26. As a result, the shut-off device 38 is unblocked again and the retraction side 18.2 of the second hydraulic consumer 12 can again be subjected to pressure by means of the position of the second valve 24 shown in FIG. 2. In the case of the embodiment of the device 32 according to the invention, it is possible to ensure, in particular, a disruption-free functioning even in specific situations of a hydraulic system, and thus to make rapid loading possible.

1. A device (32) for actuating at least one first hydraulic consumer (10) and at least one second hydraulic consumer (12),
wherein the hydraulic consumers (10, 12) can be supplied with fluid at a predefined pressure at least via a flow divider (26) for dividing a fluid flow that comes from a pressure supply (P) in predefinable partial flows, which leads to the respective hydraulic consumer (10, 12);
wherein (38) a fluid flow from the respective hydraulic consumer (10) having a higher pressure loading via the flow divider (26), to the respective hydraulic consumer (12) having a lower pressure loading, can be suppressed by means of at least one shut-off device that can be actuated, which is disposed between the flow divider (26) and at least one hydraulic consumer (12); and
wherein the at least one shut-off device (38) is disposed in a fluid connection (F2) from the flow divider (26) to the hydraulic consumer (12) having a lower pressure loading, characterized in that a control line (S) is run from the fluid connection (F1), which runs from the hydraulic consumer (10), which has the higher pressure loading to the flow divider (26), to the shut-off device (38) in such a way that the higher pressure loading actuates the shut-off device (38) in the direction of the blocking position thereof, so that in the respective pressure situation of the actuated hydraulic consumer (10, 12) a fluid pressure that is present in the fluid connection (F1) from the hydraulic consumer (10) having a higher pressure loading to the flow divider (26) does not reach the hydraulic consumer (12) having a lower pressure loading, and consequently does not actuate this consumer in an unintended manner.

2. The device according to claim 1, characterized in that, during the operation thereof, at least one shut-off device (38), which is preferably designed as a valve and, especially preferably, designed as a non-return valve, is actuated by the fluid pressure flowing through the flow divider (26) and can be blocked by the fluid pressure originating from the hydraulic consumer (10) having a respective higher pressure loading.

3. The device according to claim 1, characterized in that the control line (5) runs between a connection point (AS) of the shut-off device (38) for blocking said connection point and a branching point (AB), into which control line a fluid line (F1′), coming from the outlet (A1) of a flow divider pathway (ST1) of the flow divider (26), discharges, and into an additional fluid line (F1), which likewise runs in the direction of the consumer (10) with the higher pressure pressure loading.

4. A hydraulic system comprising at least one first hydraulic consumer (10) and at least one second hydraulic consumer (12), and a device (32) according to claim 1 for actuating the hydraulic consumer (10, 12).

5. The hydraulic system according to claim 4, characterized in that the first (10) and/or the second hydraulic consumer (12) is a fluid-actuated actuator each having two actuator sides (18.1, 20.1; 18.2, 20.2) that are separated from one another, which actuator sides can be connected to the pressure supply (P) for a movement (E1, E2) of a respective piston (14, 16) to guide fluid in an alternating manner.

6. The hydraulic system according to claim 5, characterized in that the pistons (14, 16) are each guided in a working cylinder such that said pistons can be extended and retracted, and in that the actuator sides (18.1, 18.2) allocated to a retracting movement (E1,16E2) of the respective piston (14, 16) are connected to the flow divider (26).

7. The hydraulic system according to claim 5, characterized in that one of the pistons (14) is guided such that it can be extended and retracted in a telescopic cylinder, preferably in a horizontal direction (H), in that an additional piston (16) is guided such that it can be extended and retracted in a lifting cylinder, preferably in a vertical direction (V), and in that the shut-off device (38) is disposed between the flow divider (26) and the lifting cylinder.
